(19) United States
(12) Patent Application Publication
(10) Pub. No.: US 2015/0228155 A1
(43) Pub. Date: Aug. 13, 2015

(54) DELAYED WAGER INCREASE IN VIDEO GAMING

(71) Applicants: Mary Gael Hancock, Las Vegas, NV (US); David Ward Downes, Rancho Santa Margarita, CA (US)

(72) Inventors: Mary Gael Hancock, Las Vegas, NV (US); David Ward Downes, Rancho Santa Margarita, CA (US)

(21) Appl. No.: 14/614,309

(22) Filed: Feb. 4, 2015

Related U.S. Application Data
(60) Provisional application No. 61/939,719, filed on Feb. 13, 2014.

(51) Int. Cl. G07F 17/32; G07F 17/34

(52) U.S. Cl. CPC G07F 17/3244; G07F 17/34; G07F 17/3213

(57) ABSTRACT

A wagering method and apparatus enables a new format of payline wagering. A wagering method is practiced in which symbols are randomly provided on at least one payline. Each payline should have at least three frames in the payline that are used to determine outcomes against paytables. The method may include steps of:
a first wager (a wager on the underlying game) on the at least one payline is recognized by a processor;
a first random symbol is provided in the at least one payline;
an option to place or not an additional wager on the at least one payline is exercised;
random symbols are provided in remaining frames in the at least one payline; and
the processor resolves all wagers on the at least one payline without reference to poker hand ranks.

### RELATED APPLICATION DATA

This application claims priority from U.S. Provisional Patent Application Ser. No. 61/939,719, filed 13 Feb. 2014, which application is incorporated herein by reference.

### BACKGROUND OF THE INVENTION

1. Field of the Invention

The present invention relates to the field of processor-controlled reel type gaming, whether physical reels or virtual reels are used in slot-type wagering games. The invention particularly relates to video gaming systems in which options for increased wagers may be available.

2. Background of the Art

U.S. Pat. No. 5,167,413 (Fulton) enables a poker-type card game which provides a player with an opportunity to increase the amount wagered, and therefore to increase a winning payout, even after the player has received a definite indication that the player has won. Apparatus useful with the game method include a board game version and an electronic video game version which allow a player to increase his wager after reviewing a first display of a plurality of cards.

### SUMMARY OF THE INVENTION

A wagering method and apparatus enables a new format of payline wagering and/or bonus play. A wagering method is practiced in which symbols are randomly provided on at least one payline. Each payline should have at least three frames in the payline that are used to determine outcomes against paytables. The method may include steps of:

a first wager (a wager on the underlying game) on the at least one payline is recognized by a processor;

a first random symbol is provided in the at least one payline;

an option to place or not to place an additional wager on the at least one payline is exercised;

random symbols are provided in remaining frames in the at least one payline; and

the processor resolves all wagers on the at least one payline without reference to poker hand ranks.

### BRIEF DESCRIPTION OF THE FIGURES

FIG. 1 (Prior Art) shows a standard video game apparatus useful in enabling the present technology.

FIG. 1A shows a gaming network that may be used to implement some aspects of the invention.

FIG. 1B illustrates an example of a network device that may be configured for implementing some methods of the present invention.

### DETAILED DESCRIPTION OF THE INVENTION

The present technology relates to a wagering method in which randomly provided symbols on at least one payline having at least three frames in the payline are used to determine outcomes against paytables. The paylines may have 3, 4, 5 or more frames in each payline. The paylines may be linear or non-linear or even scatter pay symbols. Scatter pay symbols are less desirable in the present practices as they may indicate an assured win upon which wagers could be increased. The symbols may be traditional symbols, playing card symbols or non-traditional symbols. Scatter pay symbols and bonus entry symbols may be used. A processor is used to at least determine outcomes when physical reels are used, and as in typical video gaming systems, the processor will also perform other tasks such as storing game information, image content, random number generation capability, random symbol provision, accounting functions, ticket-in-ticket-out function, security functionality, and the like, as further described herein. The processor and associated or ancillary components will execute a wagering event in which:

a first wager or initiation of a gaming event with potential awards based on an effective wager on the at least one payline is recognized by the processor;

a first random symbol is provided in the at least one payline. The first random symbol may be provided in any one of the frames in the at least one payline, but for visual convenience it is likely to be best provided in an end frame of the payline, either reading right-to-left, or left-to-right;

an option to place or not to place an additional wager on the at least one payline is exercised. Exercise of the option is defined as the processor recognizing at least one step of placing a second wager or, after a second wager prohibiting event has occurred, not placing the wager. A “wager prohibiting event” is defined as a specific, rule-defined event, the occurrence of which prevents placement of the second wager. Such an event can be governed, controlled or provided by a timing function in the processor that prevents any second (or other further) wager being accepted after a specific time interval or after a random time interval, after a next symbol has been randomly provided, after multiple next symbols have been randomly provided, after the processor has received specific player input (from a player input system, such as buttons, touchscreen and the like) that no wager is to be placed or a wager has been placed;

random symbols are provided in remaining frames in the at least one payline (e.g., by the motor-driven physical reels or by the processor on the visual display system. Where a physical set of reels is used to provide symbols, a first spinning reel (motor-driven) is stopped and the remaining frames would continue to be spun by a motor. The individual reels may be mapped and controlled by a processor rather than merely allowing free-spinning termination or stops of reels. In a video system, after one frame is provided with a virtual image, the other frames may be viewed as virtually continuing to spin. Where multiple opportunities are available for at least a second wager, for example, after two (or more) symbols have been provided, the remaining un-filled frames may also appear to continue spinning; and
the processor resolves all wagers or effective on the at least one payline.

One embodiment of the technology includes a wagering method in which randomly provided symbols on at least one payline having at least three frames in the payline are used to determine non-poker outcomes against paytables in which:
a first wager or effective wager in a bonus event on a non-poker event outcome on the at least one payline is recognized by a processor;
a first random symbol is (or a first subset of random symbols, but less than the entire payline are) provided in the at least one payline;
an option to place or not to place an additional wager on the at least one payline is exercised;
random symbols are provided in remaining frames in the at least one payline; and the processor resolves all wagers on the at least one payline without reference to poker hand ranks in the resolution.

In the method, columns of symbols on reels may be spun to provide the random symbols in the frames. Virtual columns of virtual symbols on reels may be virtually spun on a visual display screen in communication with the processor to provide the random symbols in the frames. Resolution of the at least first wager may be dependent upon an alignment of the symbols being ordered from an end of the payline (linear or non-linear) or mere presence within a payline (scatter pay symbols) through remaining symbols in the payline. This is a further distinction from standard video poker games where most standard payoffs are based upon total collective analysis of all symbols, not the order of the symbols.

By way of example, in symbol reel play, it is typical for paylines to have a starting point at one end of the payline, typically the far left side of the frames (the symbols in the first column). Whether or not the first revealed symbol is in the first column or not is not critical to the underlying play of the game, even when the game resolution requires a sequence of symbols (in linear or non-linear order). However, it can be important in both game design and in impacting strategy without necessarily impacting probabilities of successful outcomes after the first resolution. Looking for example at a 3-row and 5-column display, if at least three consecutive symbols are required for a favorable outcome resolution, whether the first revealed symbol is shown in the first, second or third column does not alter the probability of a successful ultimate outcome. This is because whether the first, second or third frame is revealed, it would still require that the next two of the remaining first three frames match the first revealed symbol. That probability is the same independent of the position of the first revealed symbol in the first second or third column. The probability of a successful outcome does change in a 3×5 display format if the first revealed symbol is in the fourth column (where all of the first three symbols must match) or fifth column (where all of the first three or first four columns must match). The hold for the casino can be adjusted by the position of the revealed frames and the number of revealed frames provided before the additional wager is provided. For example, if two frames are revealed before the additional wager is allowed, the probability for a positive outcome is greatest with two of the first three frames revealed, then with two of the first four frames revealed (but not all in the first three frames), and then with two of the first five frames revealed (and with the last frame included).

Additionally, it is a novel feature that a timing function can be imposed on the time interval between moments when one or more informational frames are revealed and an additional wagering decision must be rendered (or the decision waived by player input). When at least one additional frame has been revealed, with or without an additional wager having been made, a second wagering option can be offered in a variant of the present technology. When additional wagering opportunities can be provided, also with timed limits on the exercise of the decision, odds and possible maximum awards may be altered to reflect a shift in informational benefit to the player. For example, if a player is shown maximum winning bonus symbols in frames 1, 3, 4 and 5, it would not be economically beneficial to allow an increase in wagering amounts when the probability of a maximum award has been dramatically shifted in favor of the player. This could be addressed modestly by having the mapped probability of the winning symbol being naturally lowest in the last revealed frame (that is the reel is originally mapped with a low probability for that symbol, rather than reordering probabilities in reels dependent upon their order of revelation), but this would likely lower the overall probability of the maximum win, since the probability would have to be extraordinarily low to moderate the shift in favor of the player. For example, both to increase the pace of the game, increase the possibility of erroneous decisions by players and increase the excitement for players, a specific time can be imposed on the second wagers after the first, or second, or third symbol is revealed. The first additional wager may be required to be elected with no more than a specific time period (20 second or less, 15 seconds or less, 10 seconds or less) or the opportunity has passed. If an additional wager is also allowed after more symbols have been revealed, the time limit may be the same or less than with the first opportunity to place a wager. However, as more information is available, the potential payout for winning events may be decreased with further information. For example, with the first wager, three 7's in the first three frames may be 10× on that outcome. On the second wager, with more information (one symbol) provided three seven's in the first three frames might pay only 8×. On a second additional wagering opportunity with still more information (two symbols), three 7's in the first three frames, the payout on the second opportunity for an additional wager may be 5× on that outcome.

Another structural variation in the possible game play would be to allow one or more passes on the game after a first symbol has been revealed. If for example the first and third frames are first revealed as a lemon and a plum (two traditional slot machine symbols of minimal or no value), the game structure may allow for the player to stop that game and advance to a next game, either by carrying over the entire first wager or in a variation of a blackjack surrender option, carrying forth one-half (or other portion) of the wager into the next game.

The present description has also referred to an “effective wager” with respect to bonus events. In many bonus events, players usually do not place accumulated value or credits at risk. If value or credits are not actually being wagered in the present game structure when used as a bonus event, the amount of winnings (usually based proportionally on a wager) may be based on the last wager made at that gaming system by the player, a minimum wager at the system or the maximum wager. A single, non-proportional paytable may also be available for the bonus event.

In the wagering method, after the first random symbol is provided and before random symbols are provided in remaining frames in the at least one payline, an additional wager is recognized by the processor. Alternatively, after the first random symbol is provided and before random symbols are provided in a single frame in remaining frames in the at least one payline an additional wager is recognized by the processor, or after the first random symbol is provided and before random symbols are provided in all remaining frames in the at least one payline an additional wager is recognized by the processor.

In performing the wagering method, after the first random symbol is provided, at least one additional random symbol may be provided in a remaining frame in the at least one payline, a second option to place or not an additional wager on the at least one payline is exercised, and then random symbols are provided in remaining frames in the at least one payline; and the processor resolves all wagers on the at least one payline.

### Wagering Game Machine Architectures

Prior Art wagering game machine architecture may be used to effect and practice example embodiments of the invention. A typical wagering game machine architecture includes a wagering game machine or terminal or bank of machines, which includes a central processing unit (CPU) connected to main memory. The CPU can include any suitable processor, such as an Intel™ Pentium processor, Intel® Core 2 Duo processor, AMD Opteron® processor, or Ultra SPARC processor. The main memory includes a wagering game unit and a wagering game animation presentation unit. In one embodiment, the wagering game unit can present the wagering games described herein, in whole or part.

The wagering game animation presentation unit receives wagering game animations generated by a content server (e.g., the content server described above) and presents the wagering game animations on a primary display and/or a secondary display of the wagering game machine in accordance with instructions from a content server. In some implementations, the main memory may also comprise a compositing unit. The compositing unit can receive, from the content server, a template animation, a randomly generated wagering game outcome, and an orientation of an object(s) of the wagering game. The compositing unit can generate the wagering game animation and present the wagering game animation (e.g., spinning wheels or other added animation) on the primary display and/or the secondary display of the wagering game machine based on the template animation, the outcome, and the orientation of the object(s).

The CPU is also connected to an input/output (I/O) bus, which can include any suitable bus technologies, such as an AGTL+ frontside bus and a PCI backside bus. The I/O bus is connected to a payout mechanism, the primary display, the secondary display, value input device, player input device, information reader, and storage unit. The player input device can include the value input device to the extent the player input device is used to place wagers. The I/O bus is also connected to an external system interface, which is connected to external systems (e.g., wagering game networks).

In one embodiment, the wagering game machine can include additional peripheral devices and/or more than one of each component discussed above. For example, in one embodiment, the wagering game machine can include multiple external system interfaces and/or multiple CPUs. In one embodiment, any of the components can be integrated or subdivided.

Any component of the architecture can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). Machine-readable media can be machine-readable storage media or machine-readable signal media. Examples of machine-readable storage media include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Examples of machine-readable signal media can be in the form of an electro-magnetic signal, an optical signal, or any suitable combination thereof.

A graphical user interface (GUI) is a type of computer application user interface that allows people to interact with a computer and computer-controlled devices. A GUI typically employs graphical icons, visual indicators or special graphical elements, along with text, labels or text navigation to represent the information and actions available to a user. The actions are usually performed through direct manipulation of the graphical elements.

A gaming apparatus may include a housing, a display system for providing at least one payline for a wagering game, with multiple symbols available for each frame of the at least one payline, a processor and a wager accounting system, wherein the processor is configured to execute code to perform the wagering methods described herein. The game may also be played on-line, with a central and distal server providing gaming content on-line or through a large area network (LAN) or wide area network (WAN). Player input systems may include any hardware capable of accessing the network and having capability of security supervision, such as smart phones, pads, tablets, processor systems (e.g., laptops, desktop, or hand-held computer systems) and the like.

A brief description of an example of a method of practicing the present technology will assist in a further understanding of the technology and its scope.

For ease and simplification of a description, a single, 5-frame payline of standard, old-fashioned slot symbols (bars, sevens, cherries, oranges, plums, lemons and blanks) will be used in the example. A standard video slot terminal, with enabling software for the process will be used. A first wager on the wagering game is placed and accepted by the processor. The five frames may spin (or the blanks frames are shown). An at least first frame symbol is revealed (in this example, a 7, one of a number of symbols that have the potential to start a winning series of symbols). At this point, or preferably at a later point, the processor (before all symbols in all frames are revealed) will allow a player to increase the first wager, usually by a multiple (within a defined range) of the initial or first wager. The processor may indicate that time is running out for the election of the option by any time-indicating function (e.g., a countdown, hourglass, shrinking bar, etc.).

There are many structural options for the sequential display of symbols in the structure of the present technology. As noted herein, certain orientations of original display of frames according to the present technology may or may not provide different quality of information affecting probabilities and decisions. Keeping that important impact of disclosure in mind, there are still neutral mechanisms according to the present technology. For example, single frames may be disclosed rather than complete columns of symbols. A single frame (e.g., out of 15 available frames in a 3×5 format), multiple frames in unconnected paylines, multiple frames in only some paylines (e.g., column 1, row 1 and column 3, row 3), partial columns (e.g., column 4, rows 2 and 3), single columns, multiple columns, and combinations of columns and single frames. For example, a first revelation may be column 1, and after a wager is placed, the second revelation (by way of non-limiting examples) may be column 3, row 2 and/or column 4, row 3. The individual frames or columns or rows in which have not been displayed may show potential activity or not. In not showing potential activity, the symbol-free areas could remain blank, white, colored or a game ineffective image. In displaying potential activity, columns may spin or have an image effect of virtually spinning, individual frames may flash or show an in-place spin image (in a virtual display system), columns may shift back and forth (e.g., up and down) to show potential stopping positions, and other forms of attractive or entertaining imagery may be used to suggest upcoming activity. These structural effects are still within the general scope of the technology enabled and presented herein.

In this present example, two out of the five symbols (symbols, numbers, tiles, and the like) are revealed. They may be in any of the five frames, but for this example, and ease of viewing, the first two cards are revealed in the first two frames. The remaining frames are still spinning or the backs of the cards are still displayed. In the simplest variant of this technology, after the period for exercising the optional additional wager has expired or the increased wager has been made, the last two playing cards (in the three remaining frames) are then revealed. The processor then resolves the first wager and any additional wager(s) against the paytable. As with bonus paytables, because an additional advantage is being provided to the player (the two revealed cards may actually assure a winning outcome as in a Jacks or Better paytable where the first two cards are a pair of Kings), the overall paytable may be adjusted to retain the “hold” for the game at a profitable level for the casino. For example, Jacks or Better may still pay 1:1, but Two Pair may also pay 1:1 (which is present on some Bonus Poker games), Three-of-a-Kind may pay either 2:1 or 3:1, and the remainder of the paytable may be standard or additionally modified. As the revelation of two cards in a single suit (moving towards a 5-card flush) or two cards with a potential 5-card straight is fairly minimal informational advantage, the impact on payouts for those events and the likelihood of a player increasing a wager based on that information would tend to be extremely small.

In a more standard slot-type 5-column display, disclosure in the first two revealed frames (while the other frames remain spinning) shows the first two (or even more advantageously for the casino) or random two, or later two frames (without display of the first frame which is generally always required payout events, except for scatter pays). After display of the first two (or first only, or three-out-of-five symbols) random signals, the player may again have to elect to place an additional wager or allow the game to continue based upon only the first wager.

It is also possible that, after exercising or not exercising the first optional wager, only a partial revelation of the remaining symbols occurs. For example, if the first two symbols are displayed and the player does not place the optional wager, the game events may provide for a third symbol to be revealed with a new option to place an additional wager. In the first optional wager, the player may be allowed to make a wager only equal to the first wager or within a defined range (e.g., 1×, 2× and 3×) of the first wager as the first increased wager. The range may be even narrower in the second optional wager, as more information has been provided to the player. The second optional wager, in addition to being possibly against a further limited or reduced paytable, may be limited to 1× and 2× the initial wager, and may even be limited to fractional wagers (e.g., 0.1, 0.2, 0.25, 0.5, etc.) of the original wager. The amount of the wager allowed may also be dependent upon the size of the original or underlying game wager. For example, if the range of allowed wagers is 1 unit to 5 units, the allowed range for (any) additional wager after partial revelation of symbols on the payline may be limited to 1 unit for initial wagers of 1 to 3 units, and may allow for 1× or 2× wagers when 4 or 5 units were initially wagered.

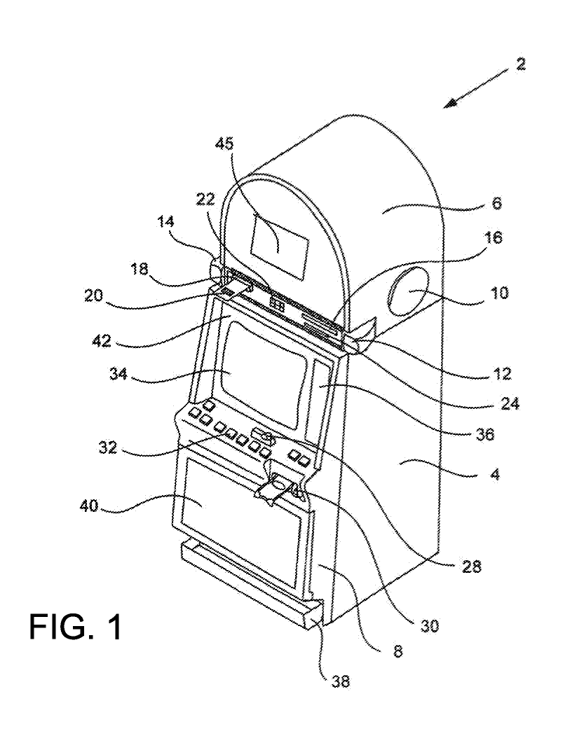

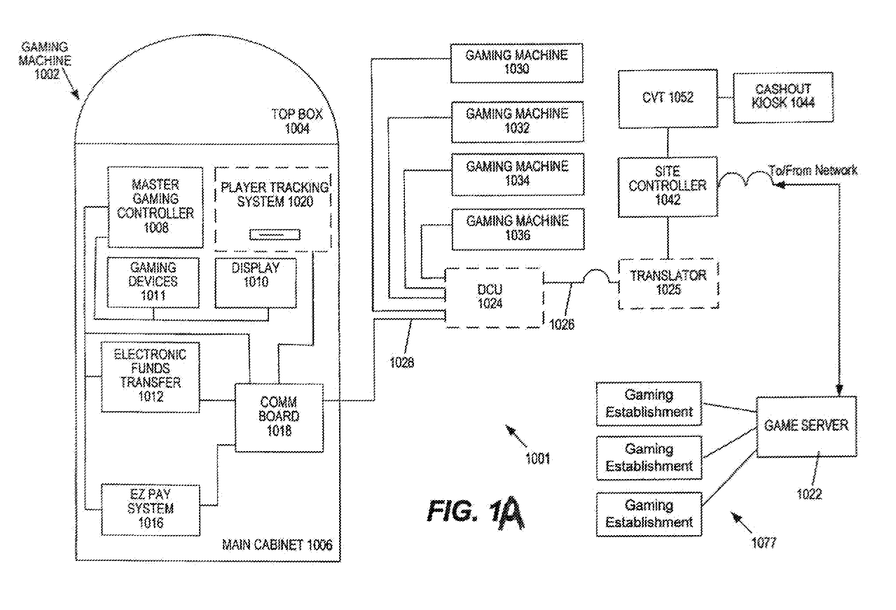

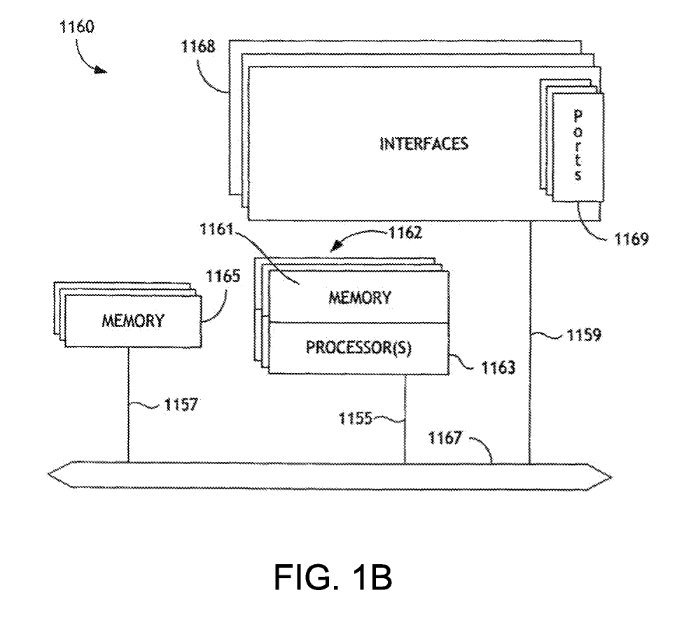

Turning next to FIG. 1, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaining system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown or in a more horizontal (table like) display unit. Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaining machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

The present technology may also be used in social media play systems as anon app or on-line wagering using personal data devices. The social media game play may be accessed through social media websites and systems, including, but not limited to Facebook™ media and outlets. Depicted in FIG. 2 is a handheld or mobile gaming machine 110. Like the free standing gaming machine 10, the handheld gaming machine 110 is preferably an electronic gaming machine configured to play a video casino game such as, but not limited to, blackjack, slots, keno, poker, blackjack, and roulette. The handheld gaming machine 110 comprises a housing or casing 112 and includes input devices, including a value input device 118 and a player input device 124. For output the handheld gaming machine 110 includes, but is not limited to, a primary display 114, a secondary display 116, one or more speakers 117, one or more player-accessible ports 119 (e.g., an audio output jack for headphones, a video headset jack, etc.), and other conventional I/O devices and ports, which may or may not be player-accessible. In the embodiment depicted in FIG. 1b, the handheld gaming machine 110 comprises a secondary display 116 that is rotatable relative to the primary display 114. The optional secondary display 116 may be fixed, movable, and/or detachable/attachable relative to the primary display 114. Either the primary display 114 and/or secondary display 116 may be configured to display any aspect of a non-wagering game, wagering game, secondary games, bonus games, progressive wagering games, group games, shared-experience games or events, game events, game outcomes, scrolling information, text messaging, emails, alerts or announcements, broadcast information, subscription information, and handheld gaming machine status.

The player-accessible value input device 118 may comprise, for example, a slot located on the front, side, or top of the casing 112 configured to receive credit from a stored-value card (e.g., casino card, smart card, debit card, credit card, etc.) inserted by a player. In another aspect, the player-accessible value input device 118 may comprise a sensor (e.g., an RF sensor) configured to sense a signal (e.g., an RF signal) output by a transmitter (e.g., an RF transmitter) carried by a player. The player-accessible value input device 118 may also or alternatively include a ticket reader, or barcode scanner, for reading information stored on a credit ticket, a card, or other tangible portable credit or funds storage device. The credit ticket or card may also authorize access to a central account, which can transfer money to the handheld gaming machine 110.

Still other player-accessible value input devices 118 may require the use of touch keys 130 on the touch-screen display (e.g., primary display 114 and/or secondary display 116) or player input devices 124. Upon entry of player identification information and, preferably, secondary authorization information (e.g., a password, PIN number, stored value card number, predefined key sequences, etc.), the player may be permitted to access a player's account. As one potential optional security feature, the handheld gaming machine 110 may be configured to permit a player to only access an account the player has specifically set up for the handheld gaming machine 110. Other conventional security features may also be utilized to, for example, prevent unauthorized access to a player's account, to minimize an impact of any unauthorized access to a player's account, or to prevent unauthorized access to any personal information or funds temporarily stored on the handheld gaming machine 110.

The player-accessible value input device 118 may itself comprise or utilize a biometric player information reader which permits the player to access available funds on a player's account, either alone or in combination with another of the aforementioned player-accessible value input devices 118. In an embodiment wherein the player-accessible value input device 118 comprises a biometric player information reader, transactions such as an input of value to the handheld device, a transfer of value from one player account or source to an account associated with the handheld gaming machine 110, or the execution of another transaction, for example, could all be authorized by a biometric reading, which could comprise a plurality of biometric readings, from the biometric device.

Alternatively, to enhance security, a transaction may be optionally enabled only by a two-step process in which a secondary source confirms the identity indicated by a primary source. For example, a player-accessible value input device 118 comprising a biometric player information reader may require a confirmatory entry from another biometric player information reader 152, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 118 may be provided remotely from the handheld gaming machine 110.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result, Though most modem general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaining machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022. Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™ marketing management, and data tracking, such as player tracking. Therefore, master gaming controller 1008 may also communicate with EFT system 1012, EZPay™ system 1016 (a proprietary cashless ticketing system of the present assignee), and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

While this invention is described in terms of preferred embodiments, there are alterations, permutations, and equivalents that fall within the scope of the invention. It should also be noted that there are many alternative ways of implementing the present invention. It is therefore intended that the invention not be limited to the preferred embodiments described herein, but instead that the invention should be interpreted as including all such alterations, permutations, and equivalents as fall within the true spirit and scope of the present invention.

The basic equipment desirable for performing the process and forming the system may include:
a) a processor configured to execute code to simulate a physical random gaming event outcome using a random number generator. A commercially available gaming processor or central processor may be used. The processor may be provided with memory, flash memory, EPROM, EEPROM, RAM, ROM, input/output ports, hard-wire or wireless communication enabling capability and the like.
b) memory storing video displayable image data of a device useful in providing the physical random gaming event outcome. The displayable image data may be segmented or may be in a continuous format. In segmented format, a first generic image data set would display a generic movement of the virtual random event generations system would be shown. For example, a first generic segment of a spinning roulette wheel with revolving ball around the edge may be shown, bouncing dice, spinning candy wheel, cards being dealt face down, and the like can be show. An individual, specific segment may be transferred from memory to the display system at the end of the generic segment. The individual, specific display data segment would then show the virtual image of the random number generated determined outcome for the game event. This method reduces the total amount of data that must be stored in displaying outcomes. This is particularly important where a single processor stores multiple games thereon.
   The present gaming technology may also be implemented for on-line gaming, communal gaming, multi-player platform gaming and the like. As the only change implemented by players during the game is wagering amounts, as opposed to play strategy, allowing multiple players to engage in a single game is easily enabled.

What is claimed:

1. A wagering method in which randomly provided symbols on at least one payline having at least three frames in the payline are used to determine outcomes against paytables in which:
a first wager on a non-poker event outcome on the at least one payline is recognized by a processor;
a first random symbol is provided in the at least one payline;
an option to place or not to place an additional wager on the at least one payline is exercised;
random symbols are provided in remaining frames in the at least one payline; and
the processor resolves all wagers on the at least one paylines without reference to poker ranks in the resolution.

2. The method of claim 1 wherein columns of symbols on reels are spun to provide the random symbols in the frames.

3. The method of claim 1 wherein virtual columns of virtual symbols on reels are virtually spun on a visual display screen in communication with the processor to provide the random symbols in the frames.

4. The wagering method of claim 1 wherein after the first random symbol is provided and before random symbols are provided in remaining frames in the at least one payline, an additional wager is recognized by the processor.

5. The wagering method of claim 1 wherein after the first random symbol is provided and before random symbols are provided in a single frame in remaining frames in the at least one payline an additional wager is recognized by the processor.

6. The wagering method of claim 1 wherein after the first random symbol is provided and before random symbols are provided in all remaining frames in the at least one payline an additional wager is recognized by the processor.

7. The wagering method of claim 1 wherein after the first random symbol is provided, at least one additional random symbol is provided in a remaining frame in the at least one payline, a second option to place or not an additional wager on the at least one payline is exercised, and then random symbols are provided in remaining frames in the at least one payline; and the processor resolves all wagers on the at least one payline.

8. The wagering method of claim 4 wherein after the first random symbol is provided, at least one additional random symbol is provided in a remaining frame in the at least one payline, a second option to place or not an additional wager on the at least one payline is exercised, and then random symbols are provided in remaining frames in the at least one payline; and the processor resolves all wagers on the at least one payline.

9. The wagering method of claim 5 wherein after the first random symbol is provided, at least one additional random symbol is provided in a remaining frame in the at least one payline, a second option to place or not an additional wager on the at least one payline is exercised, and then random symbols are provided in remaining frames in the at least one payline; and the processor resolves all wagers on the at least one payline.

10. The wagering method of claim 6 wherein after the first random symbol is provided, at least one additional random symbol is provided in a remaining frame in the at least one payline, a second option to place or not an additional wager on the at least one payline is exercised, and then random symbols are provided in remaining frames in the at least one payline; and the processor resolves all wagers on the at least one payline.

11. The wagering method of claim 4 wherein all random symbols are provided by the processor as virtual images on a display system and a time limit is imposed by the processor on execution of the option such that after expiration of that time period, the option is determined by the processor to be a waiver of the additional wager.

12. The wagering method of claim 8 wherein all random symbol are provided by the processor as virtual images on a display system.

13. The wagering method of claim 5 wherein all random symbol are provided by the processor as virtual images on a display system.

14. A wagering apparatus comprising a housing, a display system for providing at least one payline for a wagering game, with multiple symbols available for each frame of the at least one payline, a processor and a wager accounting system, wherein the processor is configured to execute code to perform the wagering method of claim 1.

15. A wagering apparatus comprising a housing, a display system for providing at least one payline for a wagering game, with multiple symbols available for each frame of the at least one payline, a processor and a wager accounting system, wherein the processor is configured to execute code to perform the wagering method of claim 2.

16. A wagering apparatus comprising a housing, a display system for providing at least one payline for a wagering game, with multiple symbols available for each frame of the at least one payline, a processor and a wager accounting system, wherein the processor is configured to execute code to perform the wagering method of claim 3.

17. A wagering apparatus comprising a housing, a display system for providing at least one payline for a wagering game, with multiple symbols available for each frame of the at least one payline, a processor and a wager accounting system, wherein the processor is configured to execute code to perform the wagering method of claim 4.

18. A wagering apparatus comprising a housing, a display system for providing at least one payline for a wagering game, with multiple symbols available for each frame of the at least one payline, a processor and a wager accounting system, wherein the processor is configured to execute code to perform the wagering method of claim 5.

19. A wagering apparatus comprising a housing, a display system for providing at least one payline for a wagering game, with multiple symbols available for each frame of the at least one payline, a processor and a wager accounting system, wherein the processor is configured to execute code to perform the wagering method of claim 13.

20. The wagering method of claim wherein the resolution of the at least first wager is dependent upon an alignment of the symbols being ordered from an end of the payline through remaining symbols in the payline.
